(19) United States
(12) Patent Application Publication
(10) Pub. No.: US 2002/0036973 A1
(43) Pub. Date: Mar. 28, 2002

(54) Optical scanning device and optical player comprising such a scanning device

(75) Inventors: Jan Willem Aarts, Eindhoven (NL); Petrus Carolus Maria Frissen, Eindhoven (NL); Fredericus Gerardus Antonius Homburg, Eindhoven (NL)

Correspondence Address: Corporate Patent Counsel, U.S. Philips Corporation, 580 White Plains Road, Terrytown, NY, 10591, US

(73) Assignee: KONINKLIJKE PHILIPS ELECTRONICS N.V.

(21) Appl. No.: 09/904,077

(22) Filed: Jul. 12, 2001

(30) Foreign Application Priority Data
Jul. 19, 2000 (EP) 00202589.8

(51) Int. Cl. G11B 7/135

(52) U.S. Cl. 369/112.23

(57) ABSTRACT

The invention relates to an optical scanning device (15) comprising an objective lens (45) with an optical axis (41). The scanning device comprises an actuator (57) by means of which the objective lens can be displaced at least in a direction parallel to the optical axis. The actuator comprises a magnetic unit (61) and an electrical coil unit (63) cooperating with the magnetic unit. According to the invention, the magnetic unit is positioned in its entirety, viewed in a direction parallel to an X-direction perpendicular to the optical axis, next to and outside the coil unit, part (95, 97, 101, 103, 107, 109) of the coil unit being present in a magnetic stray field (113, 117) of the magnetic unit. As a result, the dimensions and the mass of a moving part of the scanning device carrying the coil unit and the objective lens can be kept comparatively small.

The invention relates to an optical scanning device for scanning an information layer of an optically scannable information carrier, which scanning device is provided with a radiation source, an optical lens system with an optical axis for focusing a radiation beam supplied, in operation, by the radiation source into a scanning spot on the information layer, and an actuator by means of which the lens system can be displaced with respect to a stationary part of the scanning device at least in a direction parallel to the optical axis, the actuator being provided with an electric coil system, which is arranged in a fixed position with respect to the lens system, and a magnetic system which is arranged in a fixed position with respect to the stationary part.

The invention also relates to an optical player comprising an optical scanning device for scanning an information layer of an optically scannable information carrier, and a table, which can be rotated about an axis of rotation, on which table the information carrier can be placed, said scanning device being provided with a radiation source, an optical lens system with an optical axis for focusing a radiation beam supplied, in operation, by the radiation source into a scanning spot on the information layer, and an actuator by means of which the lens system can be displaced with respect to a stationary part of the scanning device at least in a direction parallel to the optical axis, and a displacement device by means of which at least the lens system of the scanning device can be displaced with respect to the axis of rotation mainly in a radial direction.

An optical scanning device of the type mentioned in the opening paragraphs is known from U.S. Pat. No. 5,657,172. The known scanning device can suitably be used to read and/or write, for example, a CD. By means of the actuator, the lens system of the scanning device can be displaced, in operation, in a direction parallel to the optical axis, so that, in spite of deviations in the position of the information layer with respect to the stationary part of the scanning device, a distance present between the lens system and the information layer is as constant as possible, and the radiation beam is focused on the information layer as accurately as possible. The magnetic system of the actuator of the known scanning device comprises a permanent magnet whose direction of magnetization extends perpendicularly to the optical axis. The permanent magnet is provided on a first yoke of the magnetic system, which is connected to a second yoke via a base part of the magnetic system. Between the second yoke and the permanent magnet, there is an air gap in which a magnetic field is present, which is directed substantially parallel to the direction of magnetization of the permanent magnet. In the air gap there is a part of a first electric coil of the coil system comprising wire portions extending perpendicularly to the optical axis and perpendicularly to the direction of magnetization, and parts of a second and a third electric coil of the coil system comprising wire portions extending parallel to the optical axis. Interaction between the magnetic field and a current through the first coil causes a Lorentz force which is directed parallel to the optical axis, under the influence of which the lens system is displaced in a direction parallel to the optical axis to focus the radiation beam on the information layer. Interaction between the magnetic field and a current through the second and the third coil causes Lorentz forces which are directed perpendicularly to the optical axis, under the influence of which the lens system is displaced in a tracking direction to follow the information track present on the information layer.

In the actuator of the known optical scanning device, the first yoke and the permanent magnet are surrounded by a coil holder of the first coil. The lens system is secured in a lens holder which, viewed in a direction parallel to the direction of magnetization, is arranged next to the coil holder and secured to the coil holder. As a result, the part of the known scanning device which can be moved by means of the actuator, and which comprises the lens system, the lens holder, the coil holder and the three coils, has comparatively large dimensions, and also the mass of the movable part is comparatively large.

It is an object of the invention to provide an optical scanning device of the type mentioned in the opening paragraphs, wherein the dimensions and the mass of the part of the scanning device which can be moved by means of the actuator are limited.

To achieve this object, an optical scanning device in accordance with the invention is characterized in that the magnetic system, viewed parallel to an X-direction extending perpendicularly to the optical axis, is arranged in its entirety next to and outside the coil system, at least a part of the coil system being situated in a magnetic stray field of the magnetic system. The expression “magnetic stray field” is to be taken to mean a magnetic field which extends between two poles of the magnetic system, said poles, instead of being directly opposite each other and enclosing an air gap causing the magnetic field to be substantially straight, being situated, for example, next to each other, causing the magnetic field between the two poles to be curved to a substantial degree. In the scanning device in accordance with the invention, such a mutual position of the poles is necessary because the magnetic system is situated in its entirety next to and outside the coil system. The Lorentz forces necessary to displace the lens system are generated, in operation, by the interaction between said magnetic stray field and an electric current in the coil system. As the magnetic system is situated in its entirety next to and outside the coil system, a space present within the coil system can be used to accommodate other components of the movable part of the scanning device, such as the lens system. The dimensions of the movable part of the scanning device are substantially limited thereby. As also the dimensions of a necessary holder or carrier for the lens system and the coil system are limited substantially, also the mass of the movable part of the scanning device is limited substantially.

A particular embodiment of an optical scanning device in accordance with the invention is characterized in that the magnetic system comprises a first part and a second part which are each arranged, in their entirety, next to and outside the coil system near, respectively, a first side of the lens system and a second side of the lens system which, viewed in a direction parallel to the X-direction, is opposite the first side, a first part of the coil system arranged near the first side, and a second part of the coil system arranged near the second side, being situated, at least partly, in a magnetic stray field of, respectively, the first part and the second part of the magnetic system. As the magnetic system is provided with said two parts, which are arranged at two opposite sides of the lens system to co-operate with said two parts of the coil system, the force, which can be exerted by the actuator on the lens system, is increased substantially without an appreciable increase of the dimensions and the mass of the displaceable part of the scanning device.

A further embodiment of an optical scanning device in accordance with the invention is characterized in that the first part and the second part of the magnetic system, and the first part and the second part of the coil system, viewed in a direction parallel to the X-direction, are symmetrically arranged with respect to the optical axis. By virtue thereof, it is achieved that the force exerted by the actuator on the lens system coincides as much as possible with a mass center of the displaceable part of the scanning device, as a result of which the dynamic behavior of the actuator is improved.

Yet another embodiment of an optical scanning device in accordance with the invention is characterized in that the first part and the second part of the magnetic system each comprise at least a first and a second permanent magnet which, viewed in a direction parallel to the optical axis, are arranged next to each other and have a direction of magnetization extending, respectively, parallel to the X-direction and parallel to an X′-direction opposite to the X-direction, while the first part and the second part of the coil system each comprise at least an electric coil having a first part and a second part, which are provided with wire portions extending perpendicularly to the X-direction and perpendicularly to the optical axis, said first and said second part of the coil of the first part of the coil system, viewed in a direction parallel to the X-direction, being arranged directly opposite, respectively, the first and the second magnet of the first part of the magnetic system, and said first and said second part of the coil of the second part of the coil system, viewed in a direction parallel to the X-direction, being arranged directly opposite, respectively, the first and the second magnet of the second part of the magnetic system. As the first and the second permanent magnet are arranged next to each other, an arc-shaped magnetic stray field is present in both parts of the magnetic system between the poles of the first and the second magnet. As the first and the second part of the coil of each part of the coil system are arranged directly opposite the first and the second magnet of the relevant part of the magnetic system, the two parts of the coil are situated in a part of said stray field where the magnetic field lines are directed substantially parallel to the direction of magnetization of the magnets. Interaction between this part of the stray field and an electric current through the coil causes a comparatively large Lorentz force to be generated in both parts of the coil system, which Lorentz force is directed parallel to the optical axis, the lens system being displaceable in a direction parallel to the optical axis under the influence of said Lorentz force.

A particular embodiment of an optical scanning device in accordance with the invention is characterized in that the first part and the second part of the magnetic system each comprise at least two permanent magnets which, viewed in a direction parallel to the optical axis, are arranged next to each other and have a direction of magnetization extending, respectively, parallel to the X-direction and parallel to an X′-direction opposite to said X-direction, while the coil system comprises at least one electric coil having a first part and a second part, which are provided with wire portions extending perpendicularly to the X-direction and perpendicularly to the optical axis, said first part and said second part of the coil being arranged, viewed in a direction parallel to the X-direction, directly opposite, respectively, one of the two magnets of the first part of the magnetic system and one of the two magnets of the second part of the magnetic system. In this particular embodiment, the first part and the second part of the coil are situated in a part of the stray field of the permanent magnets of, respectively, one of the two parts of the magnetic system. In said part of the stray field, the magnetic field lines are directed substantially parallel to the direction of magnetization of the magnets. Interaction between this part of the stray field and an electric current through the coil causes also a comparatively large Lorentz force, extending parallel to the optical axis, to be generated in both parts of the coil system, the lens system being displaceable in a direction parallel to the optical axis under the influence of said Lorentz force.

A further embodiment of an optical scanning device in accordance with the invention is characterized in that the X-direction extends transversely to an information track present on the information layer, and in that the first part and the second part of the magnetic system each comprise at least two permanent magnets which, viewed parallel to the optical axis, are arranged next to each other and have a direction of magnetization extending, respectively, parallel to the X-direction and parallel to an X′-direction opposite to the X-direction, while the coil system comprises an electric coil having a first part and a second part, which are provided with wire portions extending perpendicularly to the X-direction and perpendicularly to the optical axis, which parts of the coil viewed in a direction parallel to the optical axis, are arranged in a transition region of the two magnets of, respectively, the first part and the second part of the magnetic system. As the first and the second permanent magnet are arranged next to each other, an arc-shaped magnetic stray field is present in both parts of the magnetic system between the poles of the first and the second magnet. As the first and the second part of the coil are arranged in the transition region of the two magnets of, respectively, the first and the second part of the magnetic system, both parts of the coil are situated in a part of the stray fields of the two parts of the magnetic system where the magnetic field lines are directed approximately perpendicularly to the direction of magnetization of the magnets and substantially parallel to the optical axis. Interaction between this part of the stray fields and an electric current through the coil causes a comparatively large Lorentz force to be generated, which is directed parallel to the X-direction, under the influence of which Lorentz force the lens system can be displaced in a direction transverse to the information track, so that the lens system can be positioned so as to be straight above the information track.

A still further embodiment of an optical scanning device in accordance with the invention is characterized in that the X-direction extends at least substantially parallel to an information track present on the information layer, and in that the first part and the second part of the coil system each comprise at least one further electric coil having a first part and a second part, which are provided with wire portions extending parallel to the optical axis, the first part and the second part of the further coil of the first part of the coil system, viewed in a direction parallel to the X-direction, being arranged directly opposite, respectively, the first magnet and a magnetizable part of the first part of the magnetic system, which magnetizable part, viewed perpendicularly to the optical axis and perpendicularly to the X-direction, is situated next to the first magnet, and the first part and the second part of the further coil of the second part of the coil system, viewed in a direction parallel to the X-direction, being arranged directly opposite, respectively, the first magnet and a magnetizable part of the second part of the magnetic system, which magnetizable part, viewed perpendicularly to the optical axis and perpendicularly to the X-direction, is situated next to the first magnet. As the first permanent magnet and said magnetizable part are arranged next to each other, an arc-shaped magnetic stray field is present in both parts of the magnetic system between the poles of the first permanent magnet and said magnetizable part. As the first and the second part of the further coil of each part of the coil system are arranged directly opposite the first permanent magnet and the magnetizable part of the relevant part of the magnetic system, both parts of the further coil are situated in a part of said stray field where the magnetic field lines extend substantially parallel to the direction of magnetization of the permanent magnet. Interaction between this part of the stray field and an electric current through the further coil causes a comparatively large Lorentz force to be generated in both parts of the coil system, which Lorentz force is directed perpendicularly to the X-direction and perpendicularly to the optical axis, the lens system being displaceable in a direction transverse to the information track under the influence of said Lorentz force, so that the lens system can be positioned so as to be straight above the information track.

An optical player of the type mentioned in the opening paragraphs is characterized in accordance with the invention in that the optical scanning device used therein is an optical scanning device in accordance with the invention.

A number of embodiments of an optical scanning device and an optical player in accordance with the invention will be explained in greater detail hereinafter with reference to the drawing, wherein

FIG. 1 diagrammatically shows an optical player in accordance with the invention,

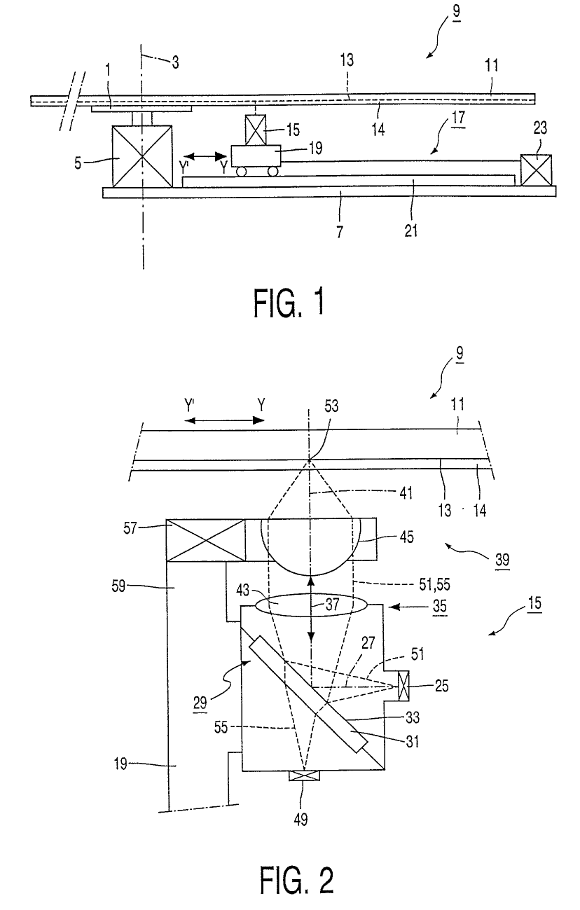

FIG. 2 diagrammatically shows an optical scanning device in accordance with the invention employed in the optical player in accordance with FIG. 1,

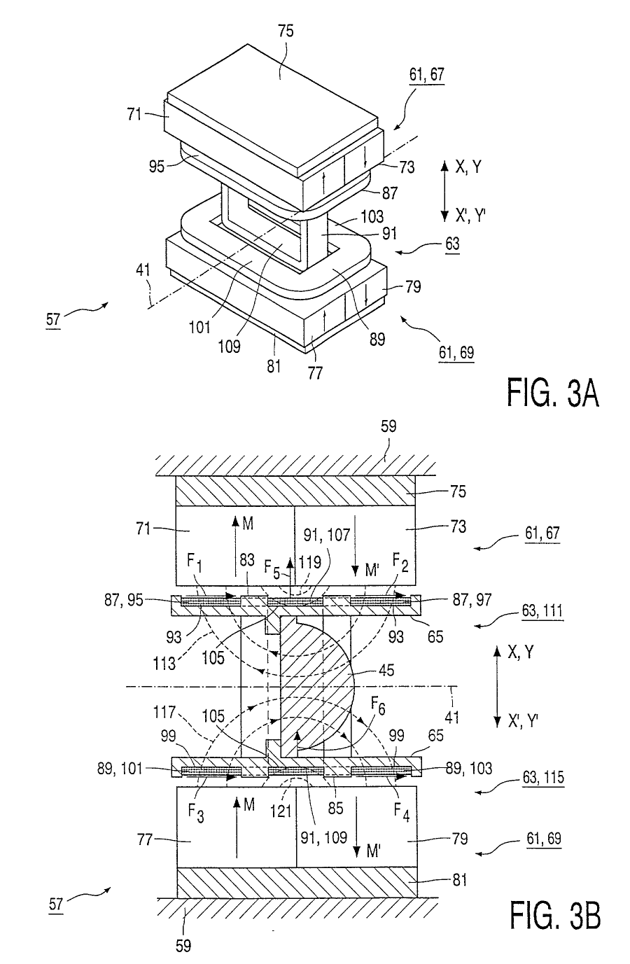

FIG. 3a diagrammatically shows a first embodiment of an actuator of the optical scanning device in accordance with FIG. 2,

FIG. 3b is a cross-sectional view of the actuator in accordance with FIG. 3a,

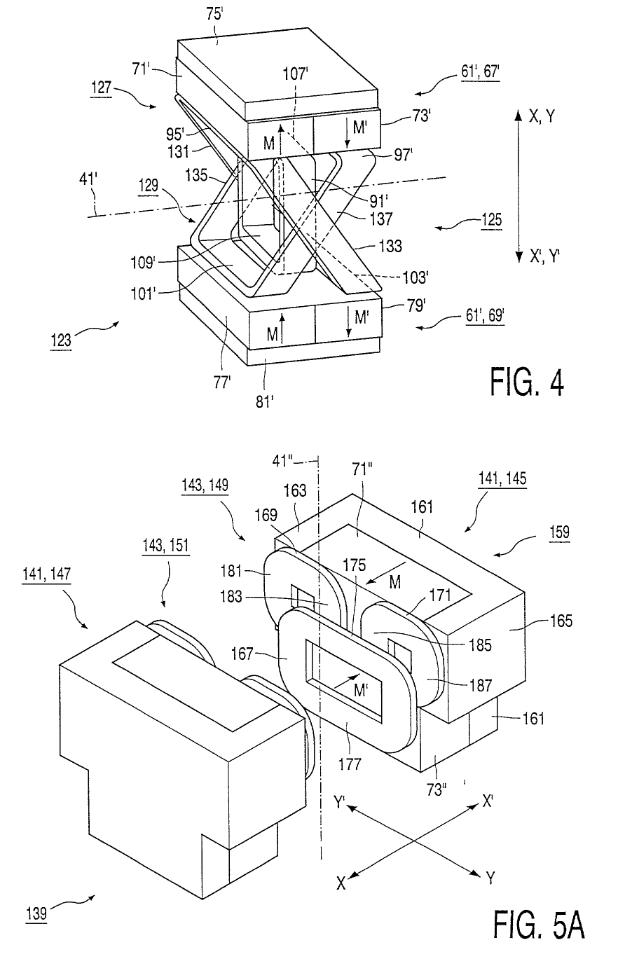

FIG. 4 diagrammatically shows a second embodiment of an actuator of the optical scanning device in accordance with FIG. 2,

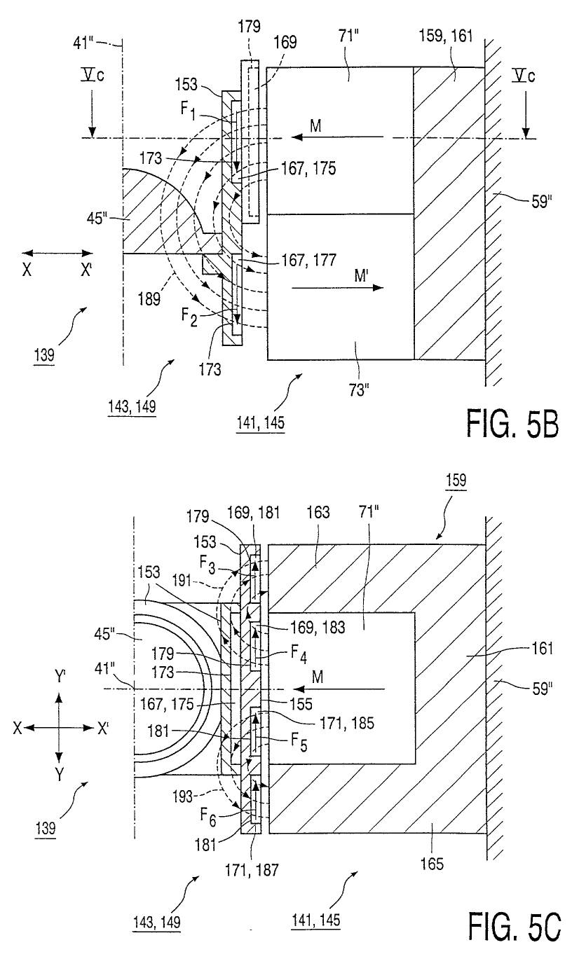

FIG. 5a diagrammatically shows a third embodiment of an actuator of the optical scanning device in accordance with FIG. 2,

FIG. 5b is a cross-sectional view of the actuator in accordance with FIG. 5a,

FIG. 5c is a cross-sectional view taken on the line Vc-Vc in FIG. 5b, and

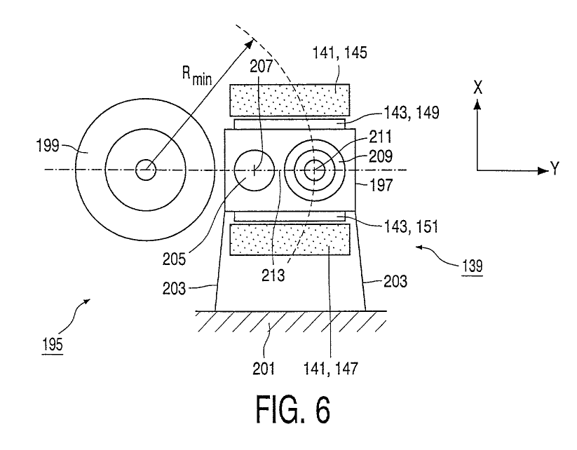

FIG. 6 diagrammatically shows an alternative embodiment of an optical scanning device in accordance with the invention, wherein the actuator in accordance with FIG. 5a is employed.

FIG. 1 diagrammatically shows an optical player in accordance with the invention, which comprises a table 1, which can be rotated about an axis of rotation 3 and driven by an electric motor 5, which is secured on a frame 7. An optically scannable information carrier 9, such as a CD, can be placed on the table 1, which information carrier is provided with a disc-shaped substrate 11 on which an information layer 13 having a spiral-shaped information track is present. The information layer 13 is covered with a transparent protective layer 14. The optical player further comprises an optical scanning device 15 in accordance with the invention for optically scanning the information track present on the information layer 13 of the information carrier 9. The scanning device 15 can be displaced with respect to the axis of rotation 3 mainly in two opposite radial directions Y and Y′ by means of a displacement device 17 of the optical player. For this purpose, the scanning device 15 is secured to a slide 19 of the displacement device 17, and the displacement device 17 is further provided with a straight guide 21 provided on the frame 7 and extending parallel to the Y direction, over which guide the slide 19 is displaceably guided, and with an electric motor 23 by means of which the slide 19 can be displaced over the guide 21. In operation, an electrical control unit of the optical player, which is not shown in FIG. 1, controls the motors 5 and 23 so as to cause the information carrier 9 to rotate about the axis of rotation 3 and, simultaneously, the scanning device 15 to be displaced parallel to the Y-direction, in such a manner that the spiral-shaped information track present on the information layer 13 of the information carrier 9 is scanned by the scanning device 15. During scanning, the information present on the information track can be read by the scanning device 15, or information can be written on the information track by the scanning device 15.

The optical scanning device 15 in accordance with the invention employed in the optical player in accordance with the invention is diagrammatically shown in FIG. 2. The scanning device 15 is provided with a radiation source 25, such as a semiconductor laser having an optical axis 27. The scanning device 15 further comprises a radiation beam splitter 29 which comprises a transparent plate 31 which is arranged at an angle of 45° with respect to the optical axis 27 of the radiation source 25, and which transparent plate comprises a reflective surface 33 which faces the radiation source 25. The scanning device 15 further comprises a collimator lens unit 35 having an optical axis 37 and an optical lens system 39 having an optical axis 41, the collimator lens unit 35 being arranged between the radiation beam splitter 29 and the lens system 39. In the example shown, the collimator lens unit 35 comprises a single collimator lens 43, while the lens system 39 comprises a single objective lens 45. In the example shown, the optical axis 37 of the collimator lens unit 35 and the optical axis 41 of the lens system 39 coincide and include an angle of 90° with the optical axis 27 of the radiation source 25. The scanning device 15 further includes an optical detector 49 which, with respect to the collimator lens unit 35, is arranged behind the radiation beam splitter and which is of a type which is known per se and commonly used. In operation, the radiation source 25 generates a radiation beam 51 which is reflected by the reflective surface 33 of the radiation beam splitter 29 and focused by the lens system 39 into a scanning spot 53 on the information layer 13 of the information carrier 9. The radiation beam 51 is reflected by the information layer 13 so as to form a reflected radiation beam 55 which is focused on the optical detector 49 via the lens system 39, the collimator lens unit 35 and the radiation beam splitter 29. To read information present on the information carrier 9, the radiation source 25 generates a continuous radiation beam 51, the optical detector 49 supplying a detection signal which corresponds to a series of elementary information characteristics on the information track of the information carrier 9, said elementary information characteristics being present in succession in the scanning spot 53. To write information on the information carrier 9, the radiation source 25 generates a radiation beam 51 which corresponds to the information to be written, a series of successive, elementary information characteristics on the information track of the information carrier 9 being generated in the scanning spot 53. It is to be noted that the invention also comprises optical scanning devices wherein the radiation source 25, the collimator lens unit 35 and the lens system 39 are differently arranged with respect to each other. For example, the invention also includes embodiments wherein the optical axis 37 of the collimator lens unit 35 and the optical axis 41 of the lens system 39 include an angle of 90° with each other, and wherein an additional mirror is arranged between the collimator lens unit 35 and the lens system 39. In these embodiments, the optical scanning device has reduced dimensions, viewed in a direction parallel to the optical axis 41 of the lens system 39. The invention also comprises, for example, embodiments wherein the radiation source 25 and the collimator lens unit 35 are not arranged on the slide 19, but in a fixed position with respect to the frame 7, and wherein the optical axis 37 of the collimator lens unit 35 is directed parallel to the radial directions Y, Y′. In these embodiments, only the lens system 39 and an additional mirror are provided on the slide 19, so that the displaceable mass of the slide 19 is reduced.

As is further shown in FIG. 2, the optical scanning device 15 comprises an actuator 57, which will be discussed in greater detail hereinafter, and by means of which the lens system 39 can be displaced with respect to a stationary part 59 of the scanning device 15 over comparatively small distances in a direction parallel to the optical axis 41, and over comparatively small distances in a direction parallel to the Y-direction. By displacing the lens system 39 by means of the actuator 57 in a direction parallel to the optical axis 41, the scanning spot 53 is focused with a desired accuracy on the information layer 13 of the information carrier 9. By displacing the lens system 39 in a direction parallel to the Y-direction by means of the actuator 57, the scanning spot 53 is maintained, with a desired accuracy, on the information track to be followed. For this purpose, the actuator 57 is controlled by said control unit of the optical player, which receives a focusing error signal as well as a tracking error signal from the optical detector 49.

FIGS. 3a and 3b diagrammatically show the actuator 57. For the sake of simplicity, FIG. 3a only shows a magnetic system 61 and an electric coil system 63 of the actuator 57. FIG. 3b is a cross-sectional view of the actuator 57, and the objective lens 45 is also shown in said Figure. The magnetic system 61 is arranged in a fixed position with respect to the stationary part 59 of the scanning device 15, while the electric coil system 63 is arranged in a fixed position with respect to a lens holder 65, also shown in FIG. 3b, of the scanning device 15, wherein the objective lens 45 is secured. The lens holder 65 is suspended, in a manner which is known per se and commonly applied, with respect to the stationary part 59 by means of, for example, four elastic metal rods, which are not shown in FIGS. 3a and 3b, the lens holder 65 being displaceable, while elastically deforming the rods, over small distances in a direction parallel to the optical axis 41 and parallel to the radial Y-direction, said elastic rods also being used to supply an electric current to the coil system 63.

The magnetic system 61 comprises a first part 67 and a second part 69. The first part 67 and the second part 69 of the magnetic system 61 are each arranged, in their entirety, next to and outside the electric coil system 63 and the lens holder 65, so as to be near, respectively, a first side 83 and a second side 85 of the lens holder 65, which second side, viewed in a direction parallel to the X-direction, is opposite the first side 83. In the example of the actuator 57 shown here, the X-direction is directed so as to be parallel to the radial Y-direction, for reasons which will be explained hereinafter, i.e. the X-direction is directed so as to be perpendicular to the information track present on the information layer 13 of the information carrier 9. The first part 67 comprises a first permanent magnet 71 and a second permanent magnet 73 which, viewed in a direction parallel to the optical axis 41, are arranged next to each other on a closing yoke 75 manufactured from a magnetizable material, said permanent magnets having, respectively, a direction of magnetization M directed parallel to the X-direction, and a direction of magnetization M′ directed parallel to an X′-direction, which is opposite to the X-direction. The second part 69 comprises a first permanent magnet 77 and a second permanent magnet 79 which, viewed in a direction parallel to the optical axis 41, are arranged next to each other on a closing yoke 81 manufactured from a magnetizable material, which first and second permanent magnets have, respectively, a direction of magnetization M which is directed parallel to the X-direction, and a direction of magnetization M′ extending parallel to an X′-direction, which is directed opposite to the X-direction. The electric coil system 63 comprises a first electric coil 87, a second electric coil 89 and a third electric coil 91. The first electric coil 87 is situated on the first side 83 of the lens holder 65 and is wound in a first coil holder 83 which is integrated with the lens holder 65. The first coil 87 extends substantially in an imaginary plane extending perpendicularly to the X-direction, and comprises wire portions 95 extending perpendicularly to the X-direction and perpendicularly to the optical axis 41, and wire portions 97 extending perpendicularly to the X-direction and perpendicularly to the optical axis 41. The second electric coil 89 is situated on the second side 85 of the lens holder 65 and is wound in a second coil holder 89 which is integrated with the lens holder 65. The second coil 89 also extends substantially in an imaginary plane, which is directed perpendicularly to the X-direction, and comprises wire portions 101 extending perpendicularly to the X-direction and perpendicularly to the optical axis 41, and wire portions 103 extending perpendicularly to the X-direction and perpendicularly to the optical axis 41. The third electric coil 91 is wound in a third coil holder 105 which is integrated with the lens holder 65, and said third electric coil extends substantially in an imaginary plane directed perpendicularly to the optical axis 41. The third coil 91 comprises wire portions 107 directed perpendicularly to the X-direction and perpendicularly to the optical axis 41, and wire portions 109 directed perpendicularly to the X-direction and perpendicularly to the optical axis 41. The first coil 87 and the wire portions 107 of the third coil 91 form a first part 111, arranged at the first side 83, of the electric coil system 63, which is situated in a magnetic stray field 113 of the first part 67 of the magnetic system 61. The second coil 89 and the wire portions 109 of the third coil 91 form a second part 115, arranged at the second side 85, of the electric coil system 63, which is situated in a magnetic stray field 117 of the second part 69 of the magnetic system 61.

As shown in FIG. 3b, the wire portions 95 and 97 of the first coil 87 are arranged, viewed in a direction parallel to the X-direction, substantially straight across, respectively, the first permanent magnet 71 and the second permanent magnet 73 of the first part 67 of the magnetic system 61. The wire portions 101, 103 of the second coil 89 are arranged, viewed in a direction parallel to the X-direction, substantially straight opposite, respectively, the first permanent magnet 77 and the second permanent magnet 79 of the second part 69 of the magnetic system 61. As the magnets 71 and 73, and the magnets 77 and 79, are arranged next to each other, and the movable part of the actuator 57, i.e. the objective lens 45, the lens holder 65 and the coils 87, 89, 91 do not comprise components made from a magnetizable material, the magnetic stray fields 113, 117 present between the poles of the magnets 71, 73 and 77, 79 are substantially arc-shaped, as diagrammatically shown in FIG. 3b. As the wire portions 95, 97, 101, 103 are arranged substantially straight opposite the magnets 71, 73, 77, 79, the wire portions 95, 97, 101, 103 are each situated in a part of the relevant magnetic stray field 113, 117 where the magnetic field lines are directed substantially parallel to the direction of magnetization M, M′ of the magnets 71, 73, 77, 79. Interaction between these parts of the magnetic stray fields 113, 117 and an electric current through the wire portions 95, 97, 101, 103, which are directed perpendicularly to the X-direction and perpendicularly to the optical axis 41, causes Lorentz forces F₁, F₂, F₃ and F₄ to be exerted on the wire portions 95, 97, 101, 103, which Lorentz forces are directed substantially parallel to the optical axis 41. The first coil 87 and the second coil 89 are arranged in series in such a manner that the Lorentz forces F₁, F₂, F₃ and F₄ extend in an equal direction, so that the objective lens 45 can be displaced in a direction parallel to the optical axis 41 under the influence of the Lorentz forces F₁, F₂, F₃ and F₄. As is further shown in FIG. 3b, the wire portions 107 of the third coil 91 are present, viewed in a direction parallel to the optical axis 41, in a transition area 119 of the permanent magnets 71, 73 of the first part 67 of the magnetic system 61. Similarly, the wire portions 109 of the third coil 91 are present, viewed in a direction parallel to the optical axis 41, in a transition area 121 of the permanent magnets 77, 79 of the second part 69 of the magnetic system 61. As the wire portions 107, 109 are arranged in said transition areas 119, 121, the wire portions 107, 109 are each situated in a part of the relevant magnetic stray field 113, 117 where the magnetic field lines are directed substantially perpendicularly to the direction of magnetization M, M′ of the magnets 71, 73, 77, 79, i.e. parallel to the optical axis 41. Interaction between these parts of the magnetic stray fields 113, 117 and an electric current through the wire portions 107, 109 of the third coil 91, which are directed perpendicularly to the X-direction and perpendicularly to the optical axis 41, causes Lorentz forces F₅, F₆ to be exerted on the wire portions 107, 109, which Lorentz forces are directed substantially parallel to the X-direction. As the X-direction is directed parallel to the radial Y-direction, the objective lens 45 can be displaced, under the influence of the Lorentz forces F₅, F₆, over comparatively small distances in a direction parallel to the Y-direction, i.e. perpendicularly to the information track present on the information layer 13 of the information carrier 9. The interspace between the wire portions 107 and the first part 67 of the magnetic system 61, and between the wire portions 109 and the second part 69 of the magnetic system 61, are sufficient to enable said displacements of the objective lens 45 in a direction parallel to the Y-direction.

As the first part 67 and the second part 69 of the magnetic system 61 are arranged, in their entirety, next to and outside the electric coil system 61, a space present inside the coil system 61 can be used to accommodate other components of the movable part of the scanning device 15. In the example shown in FIGS. 3a and 3b, the space present within the coil system 61 is used to accommodate the objective lens 45 and the lens holder 65. As a result, the dimensions of the movable part of the scanning device 15 are reduced substantially. As the objective lens 45 is arranged inside the coil system 61, the scanning device 15 comprises, as described hereinabove, a compact and light, integrated holder for both the objective lens 45 and the coil system 61. As a result, also the mass of the movable part of the scanning device 15 is limited substantially. As both parts 67 and 69 have a magnetic stray field 113, 117 for co-operating with the electric coil system 61, a comparatively large part of the coils 87, 89, 91 is situated in said magnetic stray fields 113, 117. As a result, a comparatively large part of the coils 87, 89, 91 is used to generate Lorentz forces, so that comparatively large forces can be exerted on the objective lens 45 by means of the actuator 57, and said actuator 57 has a high efficiency. As FIGS. 3a and 3b further show, the first part 67 and the second part 69 of the magnetic system 61, and the first part 111 and the second part 115 of the electric coil system 63, viewed in a direction parallel to the X-direction, are substantially symmetrically arranged with respect to the optical axis 41. By virtue thereof, it is achieved that the total force exerted by the actuator 57 on the objective lens 45 coincides substantially with a mass center of the movable part of the scanning device 15, so that the dynamic behavior of the actuator 57 is improved.

FIG. 4 diagrammatically shows a second embodiment of an actuator 123 which can be used instead of the actuator 57 in the above-described scanning device 15. Like FIG. 3a, FIG. 4 only shows, for the sake of simplicity, a magnetic system 61′ and an electric coil system 125 of the actuator 123. Components of the actuator 123 corresponding to components of the above-discussed actuator 57 are indicated by means of corresponding reference numerals. Hereinbelow, only a few differences between the actuator 123 and the actuator 57 are discussed.

As shown in FIG. 4, the magnetic system 61′ of the actuator 123 substantially corresponds to the magnetic system 61 of the actuator 57. The electric coil system 125 of the actuator 123 comprises a first electric coil 127, a second electric coil 129 and a third electric coil 91′. The third coil 91′ substantially corresponds to the third coil 91 of the actuator 57, the third coil 91′ being provided, like the third coil 91 of the actuator 57, with wire portions 107′ arranged near the first part 67′ of the magnetic system 61′, and with wire portions 109′ arranged near the second part 69′ of the magnetic system 61′, Lorentz forces being exerted, in operation, on these wire portions in a direction parallel to the Y-direction. The first electric coil 127 comprises wire portions 95′ directed perpendicularly to the X-direction and perpendicularly to the optical axis 41, which wire portions are arranged, viewed in a direction parallel to the X-direction, straight opposite the first permanent magnet 71′ of the first part 67′ of the magnetic system 61′, and wire portions 103′ directed perpendicularly to the X-direction and perpendicular to the optical axis 41′, which wire portions are arranged, viewed in a direction parallel to the X-direction, straight opposite the second permanent magnet 79′ of the second part 69′ of the magnetic system 61′. The second electric coil 129 comprises wire portions 97′, directed perpendicularly to the X-direction and perpendicularly to the optical axis 41′, which wire portions are arranged, viewed in a direction parallel to the X-direction, straight opposite the second permanent magnet 73′ of the first part 67′ of the magnetic system 61′, and wire portions 101′ directed perpendicularly to the X-direction and perpendicularly to the optical axis 41′, which wire portions are arranged, viewed in a direction parallel to the X-direction, straight opposite the first permanent magnet 77′ of the second part 69′ of the magnetic system 61′. The wire portions 95′ and 103′ of the first coil 127 are connected to each other by wire portions 131 and 133 which are arranged crosswise with respect to, respectively, wire portions 135 and 137, by means of which the wire portions 97′ and 101′ of the second coil 129 are connected to each other. The first coil 127 and the second coil 129 are arranged in series in such a manner that an electric current through the coil system 125 leads to mutually opposite currents in the wire portions 95′ of the first coil 127 and the wire portions 97′ of the second coil 129. As the first coil 127 and the second coil 129 are arranged so as to intersect each other, the electric currents in the wire portions 95′ and 101′ are rectified, and the electric currents in the wire portions 97′ and 103′ are also rectified, as a result of which rectified Lorentz forces are exerted on the wire portions 95′, 97′, 101′, 103′ in a direction parallel to the optical axis 41′.

FIGS. 5a, 5b and 5c diagrammatically show a third embodiment of an actuator 139, which can be applied instead of the actuator 57 in the above-discussed scanning device 15. For the sake of simplicity, FIG. 5a only shows a magnetic system 141 and an electric coil system 143 of the actuator 139. FIGS. 5b and 5c are cross-sectional views of the actuator 139, the objective lens 45″ also being shown. Components of the actuator 139 corresponding to components of the above-discussed actuator 57 are indicated by means of corresponding reference numerals.

The magnetic system 141 of the actuator 139 comprises a first part 145 and a second part 147, which are arranged in fixed positions with respect to the stationary part 59″ of the scanning device. The electric coil system 143 also comprises a first part 149 and a second part 151, which are arranged in fixed position with respect to a lens holder 153, visible in FIGS. 5b and 5c, wherein the objective lens 45″ is secured. The lens holder 153 is suspended with respect to the stationary part 59″ by means of four elastic metal rods, not shown in FIGS. 5a, 5b and 5c, which elastic metal rods are also used to supply an electric current to the coil system 143. The first part 145 and the second part 147 of the magnetic system 141 are each arranged, in their entirety, next to and outside the electric coil system 143 and the lens holder 153, and near, respectively, a first side 155 and, viewed in a direction parallel to an X-direction, a second side of the lens holder 153 opposite the first side 155. In the case of the actuator 139, the X-direction is directed, for reasons which will be explained hereinafter, perpendicularly to the radial Y-direction and perpendicularly to the optical axis 41′, i.e. substantially parallel to the information track present on the information layer 13 of the information carrier 9. For the sake of simplicity, FIGS. 5b and 5c only show the first part 145 of the magnetic system 141 and the first part 149 of the coil system 143, and, hereinbelow, only these first parts 145 and 149 are discussed. The second parts 147 and 151 are identical to the first parts 145 and 149, the first part 145 and the second part 147, like the first part 149 and the second part 151, being symmetrically arranged with respect to the optical axis 41″, viewed in a direction parallel to the X-direction,.

The first part 145 of the magnetic system 141 comprises a first permanent magnet 71″ and a second permanent magnet 73″ which, viewed in a direction parallel to the optical axis 41″, are arranged next to each other on a closing yoke 159 manufactured from a magnetizable material, and said permanent magnets having, respectively, a direction of magnetization M directed parallel to the X-direction, and a direction of magnetization M′ directed parallel to the X′-direction. The closing yoke 159 comprises a base part 161, a first leg 163 and a second leg 165, the first permanent magnet 71″, viewed parallel to the Y-direction, being arranged between the two legs 163 and 165. The first part 149 of the electric coil system 143 comprises a first electric coil 167, a second electric coil 169 and a third electric coil 171. The first electric coil 167 is wound in a first coil holder 173 integrated with the lens holder 153, and extends predominantly in an imaginary plane directed perpendicularly to the X-direction, and comprises wire portions 175 directed parallel to the Y-direction, and wire portions 177 directed parallel to the Y-direction. The second and the third electric coil 169 and 171 are wound, respectively, in a second coil holder 179 and a third coil holder 181, which are also integrated with the lens holder 153 and arranged between the first coil holder 173 and the first part 145 of the magnetic system 141. The second and the third coil 169 and 171 each also extend predominantly in an imaginary plane directed perpendicularly to the X-direction, and comprise, respectively, wire portions 181 and 183 which are directed parallel to the optical axis 41″ and wire portions 185 and 187 which are directed parallel to the optical axis 41″.

As shown in FIG. 5b, the wire portions 175 and 177 of the first coil 167 are arranged, viewed in a direction parallel to the X-direction, substantially straight opposite, respectively, the first permanent magnet 71″ and the second permanent magnet 73″ of the first part 145 of the magnetic system 141. In common with the above-discussed actuator 57, an arc-shaped magnetic stray field 189 is present between the poles of the permanent magnets 71″ and 73″. As the wire portions 175 and 177 of the first coil 167 are arranged approximately straight opposite the permanent magnets 71″ and 73″, the wire portions 175 and 177 are each situated in a part of the magnetic stray field 189 where the magnetic field lines are directed substantially parallel to the direction of magnetization M, M′ of the magnets 71″, 73″. Interaction between these parts of the magnetic stray field 189 and an electric current through the wire portions 175 and 177, directed parallel to the Y-direction, of the first coil 167 causes Lorentz forces F₁, and F₂ to be exerted on the wire portions 175 and 177, which Lorentz forces are directed parallel to the optical axis 41″, the objective lens 45″ being displaceable, under the influence of said Lorentz forces, in a direction parallel to the optical axis 41″. As shown in FIG. 5c, the wire portions 181 and 183 of the second coil 169 are arranged, viewed in a direction parallel to the X-direction, substantially straight opposite, respectively, the first leg 163 of the closing yoke 159 and the first permanent magnet 71″, and the wire portions 185 and 187 of the third coil 171 are arranged, viewed in a direction parallel to the X-direction, substantially straight opposite, respectively, the first permanent magnet 71″ and the second leg 165 of the closing yoke 159. An arc-shaped magnetic stray field 191 is present between the poles of the first permanent magnet 71″ and the first leg 163, while an arc-shaped magnetic stray field 193 is present between the poles of the first permanent magnet 71″ and the second leg 165. As the wire portions 181 and 183 of the second coil 169 are arranged substantially straight opposite, respectively, the first leg 163 and the first permanent magnet 71″, the wire portions 181 and 183 are each situated in a part of the magnetic stray field 191 where the magnetic field lines extend substantially parallel to the direction of magnetization M of the first permanent magnet 71″. For the same reasons, the wire portions 185 and 187 of the third coil 171 are each situated in a part of the magnetic stray field 193 where the magnetic field lines are directed substantially parallel to the direction of magnetization M of the first permanent magnet 71″. Interaction between these parts of the magnetic stray fields 191 and 193 and an electric current through the wire portions 181, 183, extending parallel to the optical axis 41″, of the second coil 169, and an electric current through the wire portions 185, 187 of the third coil 171, which wire portions also extend parallel to the optical axis 41″, causes Lorentz forces F₃, F₄, F₅ and F₆ to be exerted on the wire portions 181, 183, 185, 187, which Lorentz forces are directed parallel to the radial Y-direction. The second coil 169 and the third coil 171 are arranged in series in such a manner that the Lorentz forces F₃, F₄, F₅, F₆ are rectified, so that the objective lens 45″ can be displaced, under the influence of the Lorentz forces F₃, F₄, F₅, F₆, in a direction parallel to the radial Y-direction.

In the case of the actuator 139, the X-direction, wherein the first part 145 and the second part 147 of the magnetic system 141 are arranged opposite each other, is directed perpendicularly to the Y-direction, as a result of which, viewed in a direction parallel to the radial Y-direction, no components of the actuator 139 are situated next to the electric coil system 143 and a lens holder 153. By virtue thereof, the actuator 139 can particularly suitably be used in an alternative embodiment of an optical scanning device 195 in accordance with the invention, which is diagrammatically shown in FIG. 6. FIG. 6 diagrammatically shows the first part 145 and the second part 147 of the magnetic system 141 of the actuator 139, which parts, viewed in a direction parallel to the X-direction directed perpendicularly to the radial Y-direction, are arranged opposite each other on either side of the electric coil system 143 and a lens holder 197. FIG. 6 further diagrammatically shows the first part 149 and the second part 151 of the coil system 143, a turntable 199 of an optical player in accordance with the invention of which the scanning device 195 forms part, a stationary part 201 of the scanning device 195, which can be displaced over comparatively large distances, by means of a displacement device, not shown, of the optical player, along a radius 213 of the turntable 199, which radius is directed parallel to the Y-direction, and elastic suspension elements 203 by means of which the lens holder 197 is suspended with respect to the stationary part 201. By means of the actuator 139, the lens holder 197 can be displaced over comparatively small distances along the radius 213, thereby elastically deforming the suspension elements 203. As is further shown in FIG. 6, a first objective lens 205 having an optical axis 207, and a second objective lens 209 having an optical axis 211 are provided in the lens holder 197, the optical axes 207, 211 both intersecting the radius 213 of the turntable 199. By using the two objective lenses 205, 209, the scanning device 195 can suitably be used for scanning information carriers of at least two different types or standards, such as for example CD and DVD, or DVD and DVR. As the two objective lenses 205, 209 are situated on the radius 213, the scanning device 195 does not have to comprise an additional actuator for exchanging the objective lenses 205, 209 in a scanning position defined on the radius 213, because the objective lenses 205, 209 can be exchanged in said scanning position by means of said displacement device of the optical player. As the objective lenses 205, 209 must both be capable of reaching a position situated at a minimum radius Rₘᵢₙ from the axis of rotation of the turntable 199, there is hardly any space left between the turntable 199 and the first objective lens 205, viewed in a direction parallel to the radial Y-direction, in a situation shown in FIG. 6, wherein the second objective lens is situated at the minimum radius Rₘᵢₙ. The actuator 139 is particularly suitable for use in the scanning device 195, because the actuator 139, viewed in a direction parallel to the radial Y-direction, does not have components between the first objective lens 205 and the turntable 199.

By means of the above-described optical players in accordance with the invention, it is possible, during scanning the information layer 13 of the information carrier 9, to read information present on the information layer 13 or to write information on the information layer 13. It is to be noted that the invention also relates to optical players and optical scanning devices by means of which only information present on an information layer of an information carrier can be read.

It is finally noted that the invention also comprises embodiments of an optical scanning device wherein the magnetic system and the electric coil system are composed in a manner which differs from the embodiments of the scanning device described hereinabove. For example, the invention also includes embodiments wherein, only on a single side of the lens holder, the magnetic system is arranged next to and outside the coil system. In the case of the actuator 57 shown in FIG. 3a, such an embodiment is obtained, for example, by leaving out the second part 69 of the magnetic system 61 and the second coil 89 of the electric coil system 63, or in the case of the actuator 139 shown in FIG. 5a, by leaving out the second part 147 of the magnetic system 141 and the second part 151 of the electric coil system 143.

1. An optical scanning device for scanning an information layer of an optically scannable information carrier, which scanning device is provided with a radiation source, an optical lens system with an optical axis for focusing a radiation beam supplied, in operation, by the radiation source into a scanning spot on the information layer, and an actuator by means of which the lens system can be displaced with respect to a stationary part of the scanning device at least in a direction parallel to the optical axis, the actuator being provided with an electric coil system, which is arranged in a fixed position with respect to the lens system, and a magnetic system which is arranged in a fixed position with respect to the stationary part, characterized in that the magnetic system, viewed parallel to an X-direction extending perpendicularly to the optical axis, is arranged in its entirety next to and outside the coil system, at least a part of the coil system being situated in a magnetic stray field of the magnetic system.

2. An optical scanning device as claimed in claim 1, characterized in that the magnetic system comprises a first part and a second part which are each arranged, in their entirety, next to and outside the coil system near, respectively, a first side of the lens system and a second side of the lens system which, viewed in a direction parallel to the X-direction, is opposite the first side, a first part of the coil system arranged near the first side, and a second part of the coil system arranged near the second side, being situated, at least partly, in a magnetic stray field of, respectively, the first part and the second part of the magnetic system.

3. An optical scanning device as claimed in claim 2, characterized in that the first part and the second part of the magnetic system, and the first part and the second part of the coil system, viewed in a direction parallel to the X-direction, are symmetrically arranged with respect to the optical axis.

4. An optical scanning device as claimed in claim 2 or 3, characterized in that the first part and the second part of the magnetic system each comprise at least a first and a second permanent magnet which, viewed in a direction parallel to the optical axis, are arranged next to each other and have a direction of magnetization extending, respectively, parallel to the X-direction and parallel to an X′-direction opposite to the X-direction, while the first part and the second part of the coil system each comprise at least an electric coil having a first part and a second part, which are provided with wire portions extending perpendicularly to the X-direction and perpendicularly to the optical axis, said first and said second part of the coil of the first part of the coil system, viewed in a direction parallel to the X-direction, being arranged directly opposite, respectively, the first and the second magnet of the first part of the magnetic system, and said first and said second part of the coil of the second part of the coil system, viewed in a direction parallel to the X-direction, being arranged directly opposite, respectively, the first and the second magnet of the second part of the magnetic system.

5. An optical scanning device as claimed in claim 2 or 3, characterized in that the first part and the second part of the magnetic system each comprise at least two permanent magnets which, viewed in a direction parallel to the optical axis, are arranged next to each other and have a direction of magnetization extending, respectively, parallel to the X-direction and parallel to an X′-direction opposite to said X-direction, while the coil system comprises at least one electric coil having a first part and a second part, which are provided with wire portions extending perpendicularly to the X-direction and perpendicularly to the optical axis, said first part and said second part of the coil being arranged, viewed in a direction parallel to the X-direction, directly opposite, respectively, one of the two magnets of the first part of the magnetic system and one of the two magnets of the second part of the magnetic system.

6. An optical scanning device as claimed in claim 2 or 3, characterized in that the X-direction extends transversely to an information track present on the information layer, and in that the first part and the second part of the magnetic system each comprise at least two permanent magnets which, viewed parallel to the optical axis, are arranged next to each other and have a direction of magnetization extending, respectively, parallel to the X-direction and parallel to an X′-direction opposite to the X-direction, while the coil system comprises an electric coil having a first part and a second part, which are provided with wire portions extending perpendicularly to the X-direction and perpendicularly to the optical axis, said parts of the coil being arranged, viewed in a direction parallel to the optical axis, in a transition region of the two magnets of, respectively, the first part and the second part of the magnetic system.

7. An optical scanning device as claimed in claim 4 or 5, characterized in that the X-direction extends at least substantially parallel to an information track present on the information layer, and in that the first part and the second part of the coil system each comprise at least one further electric coil having a first part and a second part, which are provided with wire portions extending parallel to the optical axis, the first part and the second part of the further coil of the first part of the coil system, viewed in a direction parallel to the X-direction, being arranged directly opposite, respectively, the first magnet and a magnetizable part of the first part of the magnetic system, which magnetizable part, viewed perpendicularly to the optical axis and perpendicularly to the X-direction, is situated next to the first magnet, and the first part and the second part of the further coil of the second part of the coil system, viewed in a direction parallel to the X-direction, being arranged directly opposite, respectively, the first magnet and a magnetizable part of the second part of the magnetic system, which magnetizable part, viewed perpendicularly to the optical axis and perpendicularly to the X-direction, is situated next to the first magnet.

8. An optical player comprising an optical scanning device for scanning an information layer of an optically scannable information carrier, and a table which can be rotated about an axis of rotation, on which table the information carrier can be placed, said scanning device being provided with a radiation source, an optical lens system with an optical axis for focusing a radiation beam supplied, in operation, by the radiation source into a scanning spot on the information layer, and an actuator by means of which the lens system can be displaced with respect to a stationary part of the scanning device, at least in a direction parallel to the optical axis, and a displacement device by means of which at least the lens system of the scanning device can be displaced, with respect to the axis of rotation, mainly in a radial direction, characterized in that the optical scanning device is an optical scanning device as claimed in claim 1, 2, 3, 4, 5, 6 or 7.
